(19) United States
(12) Patent Application Publication
(10) Pub. No.: US 2021/0188691 A1
(43) Pub. Date: Jun. 24, 2021

(54) METHOD FOR MANUFACTURING GLASS SHEET

(71) Applicant: Nippon Electric Glass Co., Ltd., Shiga (JP)

(72) Inventors: Takahide FUJII, Shiga (JP); Hisatoshi AlBA, Shiga (JP); Tsuyoshi OKUNO, Shiga (JP)

(21) Appl. No.: 17/262,845

(22) PCT Filed: Aug. 7, 2019
(86) PCT No.: PCT/JP2019/031182

§ 371 Date: Jan. 25, 2021

(30) Foreign Application Priority Data
Aug. 10, 2018 (JP) 2018-151393

(51) Int. Cl. C03B 33/09; C03B 33/04

(52) U.S. Cl. CPC C03B 33/091; C03B 33/04

(57) ABSTRACT

A laser irradiation step in the present method includes irradiating a first surface (MG1) of a mother glass sheet (MG) with laser light (L) to heat a surface layer (SL) and an inner portion (IL) of the first surface (MG1), to thereby cause, through a thermal shock caused by the heating, a crack (CR) to propagate to a second surface (MG2) of the mother glass sheet (MG) along a thickness direction of the mother glass sheet (MG) while propagating along a preset cleaving line (CL).

### TECHNICAL FIELD

The present invention relates to a method of manufacturing a glass sheet having a predetermined shape by cleaving a mother glass sheet through irradiation with laser light.

### BACKGROUND ART

As is well known, various glass sheets to be used for flat panel displays (FPD), such as a liquid crystal display and an OLED display, OLED lighting, a solar cell panel, and the like are each formed into a predetermined shape through the step of cutting a mother glass sheet.

For example, in Patent Literature 1, there is disclosed laser cleaving as a technology of cutting a mother glass sheet. In this laser cleaving, first, an initial crack is formed on a mother glass sheet (glass film having a thickness of 0.2 mm or less) with a crack former, such as a diamond cutter. Next, the mother glass sheet is heated through irradiation with laser light along a preset cleaving line set on the mother glass sheet, and the heated portion is cooled by a refrigerant, such as cooling water, jetted from a cooling unit. With this result, a thermal shock (thermal stress) is generated in the mother glass sheet, and a crack is caused to propagate along the preset cleaving line (preset cutting line) through use of the initial crack as a starting point. Thus, the mother glass sheet can be cut.

### CITATION LIST

Patent Literature 1: JP 2011-116611 A

### SUMMARY OF INVENTION

### Technical Problem

In the laser cleaving according to Patent Literature 1, a CO₂ laser is used, and hence only a surface layer of the mother glass sheet is heated. Consequently, a glass film having a thickness of 0.2 mm or less is targeted. When an attempt is made to cleave a mother glass sheet having a thickness of more than 0.2 mm by the laser cleaving according to Patent Literature 1, apart in a thickness direction cannot be cleaved, and the step of applying a bending stress to the mother glass sheet to fold and separate the mother glass sheet may be required in some cases.

The present invention has been made in view of the above-mentioned circumstances and has an object to provide a method of manufacturing a glass sheet, which is capable of cleaving even a thick mother glass sheet.

### Solution to Problem

In order to achieve the above-mentioned object, according to one embodiment of the present invention, there is provided a method of manufacturing a glass sheet, comprising: an initial crack forming step of forming an initial crack on a first surface of a mother glass sheet; and a laser irradiation step of irradiating the first surface with laser light to cause a crack to propagate along a preset cleaving line through use of the initial crack as a starting point, wherein the laser irradiation step comprises irradiating the mother glass sheet with the laser light to heat a surface layer and an inner portion of the first surface, to thereby cause, through a thermal shock caused by the heating, the crack to propagate to a second surface of the mother glass sheet along a thickness direction of the mother glass sheet while propagating along the preset cleaving line.

According to this configuration, the crack that is caused to propagate from the initial crack can be caused to propagate in the entire thickness direction of the mother glass sheet by heating the inner portion as well as the surface layer of the mother glass sheet (first surface) with laser light. As a result, even a thick mother glass sheet can be separated along the preset cleaving line without applying a bending stress to the mother glass sheet, and hence a folding and separating step can be omitted. In addition, the crack is caused to propagate with laser light, and hence the generation of microcracks on a cut surface can be suppressed, and the surface roughness of the cut surface becomes satisfactory.

As the laser light, CO laser light may be used. The CO laser light can be stably radiated to the mother glass sheet with a high output, and hence can cause the crack to stably propagate along the preset cleaving line.

In order to achieve the above-mentioned object, according to one embodiment of the present invention, there is provided a method of manufacturing a glass sheet, comprising: an initial crack forming step of forming an initial crack on a first surface of a mother glass sheet; and a laser irradiation step of irradiating the first surface with laser light to cause a crack to propagate along a preset cleaving line through use of the initial crack as a starting point, wherein the laser irradiation step comprises radiating, as the laser light, CO laser light, Er laser light, Ho laser light, or HF laser light to cause the crack to propagate to a second surface of the mother glass sheet along a thickness direction of the mother glass sheet while propagating along the preset cleaving line.

According to this configuration, CO laser light, Er laser light, Ho laser light, or HF laser light is radiated, and hence the inner portion as well as the surface layer of the mother glass sheet (first surface) can be heated with laser light. Consequently, the crack that is caused to propagate from the initial crack can be caused to propagate in the entire thickness direction of the mother glass sheet. As a result, even a thick mother glass sheet can be separated along the preset cleaving line without applying a bending stress to the mother glass sheet, and hence the folding and separating step can be omitted. In addition, the crack is caused to propagate with laser light, and hence the generation of microcracks on a cut surface can be suppressed, and the surface roughness of the cut surface becomes satisfactory.

The laser light may be radiated as a circular laser spot. Here, in the laser cleaving according to the above-mentioned Patent Literature 1, in order to ensure the amount of heat required for cleaving, a CO₂ laser is radiated to the surface of the mother glass sheet in a linear shape (see paragraphs 0057 and 0059, and FIG. 1 of Patent Literature 1). For that reason, in the related-art cutting method, it was difficult to form the preset cleaving line into a curve or to efficiently cut out a relatively small glass sheet from the mother glass sheet. In contrast, in the present invention, laser light is radiated to the mother glass sheet as a circular laser spot, and hence the scannability of the laser light can be enhanced. Thus, even when the preset cleaving line comprises a curve, the laser light can be scanned along the preset cleaving line with good accuracy. Accordingly, glass sheets having a variety of shapes can be manufactured.

The laser irradiation step may comprise cooling a periphery of an irradiation position of the laser light. With this step, a thermal shock can be generated further significantly at the irradiation position of the laser light on the mother glass sheet. In addition, as described later, depending on the condition, the crack may propagate under a state of slightly deviating from the preset cleaving line in some cases. In this case, this deviation can be reduced by cooling the periphery of the irradiation position of the laser light. The cooling may be performed from the back, the front, or the side of the irradiation position of the laser light, and is performed preferably from the back.

The laser irradiation step may comprise supporting the mother glass sheet with a surface plate and cooling the surface plate. When the surface plate is cooled in this manner, the second surface (surface to be brought into contact with the surface plate) of the mother glass sheet to be placed on the surface plate can be suitably cooled. In the present invention, a thermal shock can be significantly generated at the irradiation position of the laser light on the mother glass sheet by heating caused through irradiation with the laser light and by cooling of the mother glass sheet with the surface plate.

The laser irradiation step may comprise cooling a part of the surface plate in a vicinity of a cleaving end point of the preset cleaving line. Here, at the cleaving end point, the crack does not easily propagate, and hence uncut portions are liable to be generated due to the stop of propagation of the crack in the mother glass sheet. The propagation of the crack can be accelerated at the cleaving end point by cooling a part of the surface plate to cool the vicinity of the cleaving end point of the mother glass sheet, with the result that the generation of the uncut portions can be prevented.

The initial crack forming step may comprise forming the initial crack in an inner region of the mother glass sheet. Herein, the inner region of the mother glass sheet refers to a region surrounded by an edge portion of the mother glass sheet and does not comprise the edge portion. With this configuration, in the initial crack forming step, it is possible to cut out glass sheets having a variety of shapes from the mother glass sheet even without forming the initial crack in the edge portion of the mother glass sheet.

In the method of manufacturing a glass sheet according to the embodiment of the present invention, the laser irradiation step may be performed under a condition in which a thermal stress σ_{T} (MPa) of the mother glass sheet calculated by the following expression (1) satisfies the following expression (2):

$${σ}_{T} = \frac{E \cdot α \cdot Δ T}{2 ( 1 - v )} \qquad ( 1 )$$

where E represents a Young's modulus (MPa) of the mother glass sheet, α represents a thermal expansion coefficient (/K) of the mother glass sheet, ν represents a Poisson's ratio of the mother glass sheet, and ΔT represents a difference between a temperature (K) at the irradiation position of the laser light with respect to the mother glass sheet and a temperature (K) at a position away from the irradiation position; and

40+60t≤σ_{T}σ90+60t (2)

where “t” represents a thickness (mm) of the mother glass sheet.

### Advantageous Effects of Invention

According to the present invention, even a thick mother glass sheet can be cleaved.

### BRIEF DESCRIPTION OF DRAWINGS

FIG. 1 is a perspective view for illustrating an initial crack forming step according to a first embodiment.

FIG. 2 is a perspective view for illustrating a laser irradiation step.

FIG. 3 is a side view of a mother glass sheet.

FIG. 4 is a perspective view for illustrating a laser irradiation step according to a second embodiment.

FIG. 5 is a perspective view for illustrating a laser irradiation step according to a third embodiment.

FIG. 6 is a perspective view for illustrating a laser irradiation step according to a fourth embodiment.

FIG. 7 is a perspective view for illustrating an initial crack forming step according to a fifth embodiment.

FIG. 8 is a perspective view for illustrating a laser irradiation step.

FIG. 9 is a graph for showing a relationship between the thermal stress and the thickness of a glass sheet.

FIG. 10 is a perspective view for illustrating a cutting condition of a mother glass sheet in each of Examples.

FIG. 11 is a perspective view for illustrating a cutting condition of a mother glass sheet in each of Examples.

### DESCRIPTION OF EMBODIMENTS

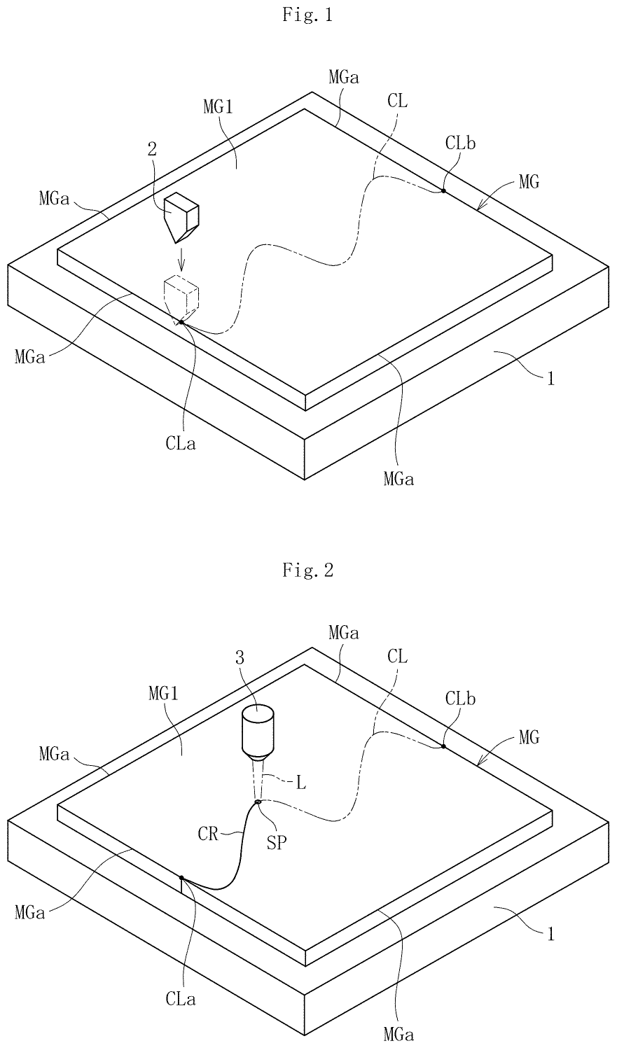

Now, embodiments of the present invention are described with reference to the drawings. In each of FIG. 1 to FIG. 3, there is illustrated a method of manufacturing a glass sheet according to a first embodiment of the present invention.

The method comprises a cleaving step of cleaving a mother glass sheet MG to form one or more glass sheets. The mother glass sheet MG is formed into a rectangular shape by cutting a glass ribbon continuously formed in a band shape in a width direction by a down-draw method, such as an overflow down-draw method, or a float method. The thickness of the mother glass sheet MG may be set to from 0.05 mm to 5 mm. From the viewpoint of attaining the effect of being capable of cleaving even the thick mother glass sheet MG, the thickness of the mother glass sheet MG is preferably more than 0.1 mm, more preferably more than 0.2 mm, still more preferably 0.3 mm or more. Meanwhile, the thickness of the mother glass sheet MG is preferably set to 3 mm or less.

Examples of the material for the mother glass sheet MG include silicate glass, silica glass, borosilicate glass, soda glass, soda lime glass, aluminosilicate glass, and alkali-free glass. Here, the alkali-free glass refers to glass that does not substantially contain an alkali component (alkali metal oxide), specifically glass having a weight ratio of the alkali component of 3,000 ppm or less. The weight ratio of the alkali component in the present invention is preferably 1,000 ppm or less, more preferably 500 ppm or less, most preferably 300 ppm or less. The mother glass sheet MG may be chemically tempered glass, and in this case, aluminosilicate glass may be used.

The cleaving step comprises a step of forming an initial crack in the mother glass sheet MG (initial crack forming step) and a laser irradiation step of causing the initial crack to propagate.

In the initial crack forming step, an initial crack is formed on apart of a first surface MG1 (hereinafter sometimes simply referred to as “surface”) of the mother glass sheet MG placed on a surface plate 1 with a clack forming member 2. As illustrated in FIG. 1, a curved preset cleaving line CL is set on the mother glass sheet MG. The preset cleaving line CL has a cleaving start point CLa set in one end portion thereof and a cleaving end point CLb set in the other end portion thereof. The cleaving start point CLa and the cleaving end point CLb are each set in an edge portion MGa of the mother glass sheet MG (in a midway portion of one side MGa of the rectangular mother glass sheet MG). The crack forming member 2 is formed of a pointed scriber, such as a sintered diamond cutter, but is not limited thereto. The crack forming member 2 may be formed of a diamond pen, a cemented carbide cutter, sandpaper, or the like.

As illustrated in FIG. 1, in the initial crack forming step, the crack forming member 2 is lowered from above the mother glass sheet MG to be brought into contact with the edge portion MGa of the mother glass sheet MG. With this step, the initial crack is formed at the cleaving start point CLa of the preset cleaving line CL.

In the laser irradiation step, laser light L is radiated to the initial crack on the first surface MG1 by a laser irradiation device 3 and is scanned along the preset cleaving line CL. Specifically, the laser irradiation device 3 is configured to be able to three-dimensionally move and to move above the mother glass sheet MG placed on the surface plate 1 in a predetermined direction, to thereby scan the laser light L from the cleaving start point CLa to the cleaving end point CLb along the preset cleaving line CL. With this configuration, as illustrated in FIG. 2, a crack CR starting from the initial crack is caused to propagate along the preset cleaving line CL. In addition, the crack CR is caused to propagate in the entire thickness direction of the mother glass sheet MG, and is caused to propagate to a second surface MG2 positioned on an opposite side of the first surface MG1.

The laser light L radiated from the laser irradiation device 3 is preferably a CO laser, an Er laser (Er: YAG laser), a Ho laser (Ho: YAG laser), or a HF laser. The laser light L may be pulse laser light or continuous laser light. When the CO laser light is used as the laser light, the wavelength thereof is set to preferably from 5.25 μm to 5.75 μm.

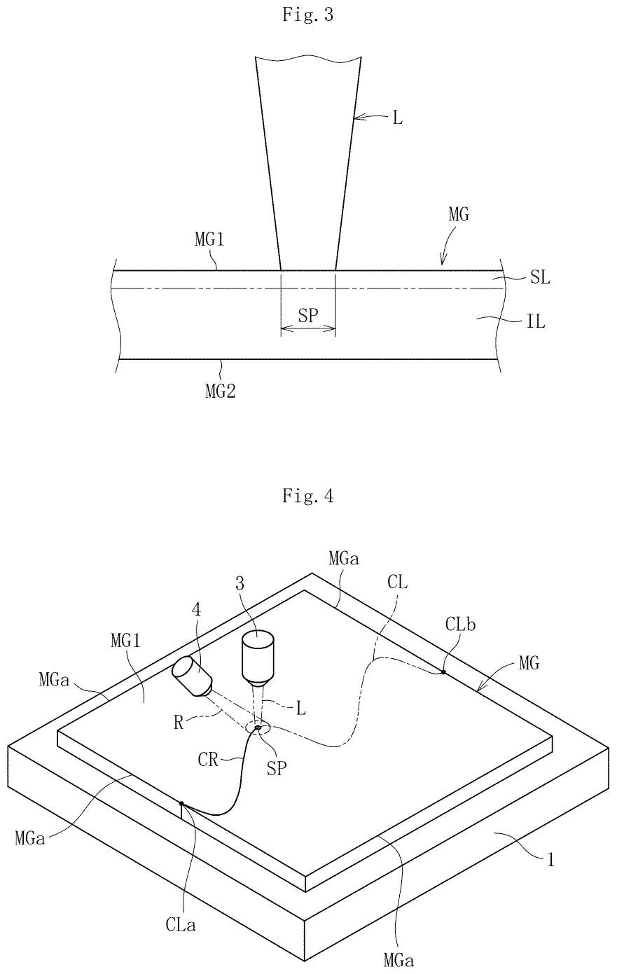

As illustrated in FIG. 2 and FIG. 3, the laser irradiation device 3 is configured to irradiate the surface MG1 of the mother glass sheet MG with the laser light L so that a circular laser spot SP is formed. The irradiation diameter (spot diameter) of the laser light L is preferably from 1 mm to 8 mm, more preferably from 2 mm to 6 mm.

When CO₂ laser light is used as in the related art, a surface layer SL (for example, a range from the surface MG1 to a depth of about 10 μm) of the mother glass sheet MG (first surface MG1) is only heated, and hence in order to provide the amount of heat required for cleaving, it is required to form the irradiation mode of the CO₂ laser light into an elongated shape (linear or elliptical shape) along the preset cleaving line CL. Further, it is required to cool the mother glass sheet MG with a refrigerant, such as cooling water, in order to generate a thermal shock sufficient for cleaving.

In contrast, in the method of manufacturing a glass sheet according to the first embodiment, through use of the CO laser light L or the like that can be stably radiated with a high output, an inner portion IL (for example, a range from a depth of about 10 μm to a depth of about 3,000 μm) as well as the surface layer SL of the mother glass sheet MG can be heated even with the circular laser spot SP, and the amount of heat sufficient for generating a thermal shock (thermal stress) for causing the crack CR to propagate in the thickness direction can be provided. In the present invention, the surface layer SL of the mother glass sheet MG refers to a layer extending from the surface MG1 of the mother glass sheet MG to a depth of 10 μm. The inner portion IL of the mother glass sheet MG refers to a region having a depth of more than 10 μm from the surface MG1 (see FIG. 3).

In the following Tables 1 and 2, there is shown an average transmittance of each of the mother glass sheets MG when a plurality of types of mother glass sheets MG each having a predetermined thickness are irradiated with a CO laser and a CO₂ laser.

TABLE 1

| | Type of glass | | | | |
|---|---|---|---|---|---|
| | Alkali- | Alkali- | Boro- | | |
| | free | free | silicate | Soda | Soda |
| Thermal expansion | 38 | 45 | 66 | 90 | 91 |
| coefficient | | | | | |
| (×10⁻⁷/K) | | | | | |
| Thickness (mm) | 0.5 | 0.5 | 0.5 | 0.5 | 0.5 |
| Average | 0.2 | 0.2 | 0.1 | 0.9 | 0.9 |
| transmittance (%) | | | | | |
| (Wavelength: 5.25 | | | | | |
| μm to 5.75 μm) | | | | | |
| Average | 0 | 0 | 0 | 0 | 0 |
| transmittance (%) | | | | | |
| (Wavelength: 10.6 | | | | | |
| μm) | | | | | |

TABLE 2

| | Type of glass | | | | |
|---|---|---|---|---|---|
| | Alkali- | Alkali- | Alkali- | Alkali- | Alkali- |
| | free | free | free | free | free |
| Thermal expansion | 38 | 38 | 38 | 38 | 38 |
| coefficient | | | | | |
| (×10⁻⁷/K) | | | | | |
| Thickness (mm) | 0.1 | 0.2 | 0.5 | 0.7 | 1.1 |
| Average | 26.8 | 7.4 | 0.2 | 0.05 | 0.01 |
| transmittance (%) | | | | | |
| (Wavelength: 5.25 | | | | | |
| μm to 5.75 μm) | | | | | |
| Average | 0 | 0 | 0 | 0 | 0 |
| transmittance (%) | | | | | |
| (Wavelength: 10.6 | | | | | |
| μm) | | | | | |

As shown in Tables 1 and 2, the wavelength of the CO laser has a peak in the vicinity of from 5.25 μm to 5.75 μm, and the average transmittance of each of the various mother glass sheets MG at this wavelength is not zero. That is, the radiated CO laser is not entirely absorbed on the surface of the mother glass sheet MG, but is partially absorbed inside the glass sheet, and the remaining portion is transmitted through the mother glass sheet MG. As a result, with the CO laser, the inner portion of the mother glass sheet MG as well as the surface thereof can be heated.

Meanwhile, the wavelength of the CO₂ laser has a peak in the vicinity of 10.6 μm, and the average transmittance of each of the various mother glass sheets MG in this vicinity is zero. In this case, most of the radiated CO₂ laser is absorbed on the surface of the mother glass sheet MG, and is not absorbed inside the mother glass sheet MG. Consequently, the inner portion of the mother glass sheet MG cannot be heated by the CO₂ laser.

In the method of manufacturing a glass sheet according to the first embodiment, the crack CR is caused to propagate in the thickness direction by heating the inner portion IL as well as the surface layer SL of the mother glass sheet MG. With this result, the mother glass sheet MG can be separated along the preset cleaving line CL without applying a bending stress to the mother glass sheet MG, and hence a folding and separating step can be omitted. In addition, it becomes possible to cut the mother glass sheet MG without cooling the mother glass sheet MG with a refrigerant as in the related art. From the viewpoint of accelerating the propagation of the crack CR, it is preferred that the irradiation part of the laser light L and the periphery thereof be cooled by jetting a refrigerant from a nozzle as in a second embodiment described later. From the viewpoint of simplifying the configuration of the laser irradiation device 3, it is preferred that the mother glass sheet MG be cut without cooling the irradiation part of the laser light L and the periphery thereof by jetting a refrigerant.

In addition, when the laser light L is radiated so that the circular laser spot SP is formed, the mother glass sheet MG can be suitably cut even when the preset cleaving line CL is formed into a curved shape. With this result, glass sheets having a further variety of shapes can be cut out from the mother glass sheet MG.

In FIG. 4, there is illustrated a method of manufacturing a glass sheet according to a second embodiment of the present invention. The second embodiment is different from the first embodiment in that, in the cleaving step, the periphery of the irradiation part (laser spot SP) of the laser light L is cooled by a refrigerant R (for example, air) jetted from a cooling device 4.

The cooling device 4 is configured to move following the laser irradiation device 3. The cooling device 4 is configured to jet the refrigerant R from a nozzle thereof toward the irradiation part (laser spot SP) of the laser light L and the periphery thereof. As the refrigerant R, an inert gas, such as He or Ar, or a N₂ gas that is non-oxidizing is suitably used in addition to air. In the second embodiment, through cooling of the irradiation part of the laser light L and the periphery thereof with the refrigerant R, a thermal shock for causing the crack CR to propagate can be more significantly generated. When a CO laser is used, CO laser light absorbs moisture, and hence the output of the CO laser is attenuated by the moisture. As a result, it is better not to use water as the refrigerant R. However, this is not the case when the output attenuation is effectively used.

The laser irradiation device 3 and the cooling device 4 may be integrally formed. For example, a jetting port of the nozzle of the cooling device 4 may be formed into an annular shape, and the laser irradiation device 3 may be arranged on an inner side of the jetting port having an annular shape.

Here, as shown in Examples described later, depending on the cutting condition, the crack CR may propagate under a state of slightly deviating from the preset cleaving line CL in some cases. In this case, this deviation can be reduced by cooling the periphery of the irradiation part (laser spot SP) of the laser light L. The cooling may be performed from the back, the front, or the side of the irradiation part (laser spot SP) of the laser light L, and is preferably performed from the back as illustrated in FIG. 4 from the viewpoint of further reducing the deviation. The front, the back, and the side are based on a scanning direction (traveling direction) of the laser light L. For example, performing cooling from the front means that cooling is performed through use of the cooling device 4 arranged on the cleaving end point CLb side with respect to the laser spot SP (laser irradiation device 3). In addition, performing cooling from the back means that cooling is performed through use of the cooling device 4 arranged on the cleaving start point CLa side with respect to the laser spot SP (laser irradiation device 3).

The jetting range of the refrigerant R by the nozzle of the cooling device 4 may not overlap the laser spot SP. That is, the refrigerant R may be jetted to a position away from the laser spot SP. From the viewpoint of further reducing the deviation of the crack CR, the distance between the jetting range of the refrigerant R by the nozzle of the cooling device 4 and the laser spot SP is preferably shorter, and the jetting range of the refrigerant R more preferably overlaps the laser spot SP partially or entirely. Here, the jetting range of the refrigerant R by the nozzle means a range which the refrigerant R jetted from the nozzle directly reaches and cools the mother glass sheet MG, and excludes the case in which the refrigerant R that is brought into contact with the mother glass sheet MG and changed in a flow direction indirectly reaches and cools the laser spot SP.

From the viewpoint of further reducing the deviation of the crack CR from the preset cleaving line CL, it is preferred that the scanning speed of the laser light L be low. For example, in the case where the material for the mother glass sheet MG is alkali-free glass, when the thickness is 0.4 mm or more, the scanning speed of the laser light L is set to preferably from 3 mm/sec to 15 mm/sec. When the thickness is less than 0.4 mm, the scanning speed is set to preferably from 3 mm/sec to 100 mm/sec. The preferred scanning speed of the laser light L varies depending on the material for the mother glass sheet MG, and tends to increase along with an increase in thermal expansion coefficient. In addition, the preferred scanning speed of the laser light L tends to increase along with a decrease in thickness of the mother glass sheet MG. The flow rate of the refrigerant R jetted from the nozzle may be set to, for example, from 10 l/min to 50 l/min.

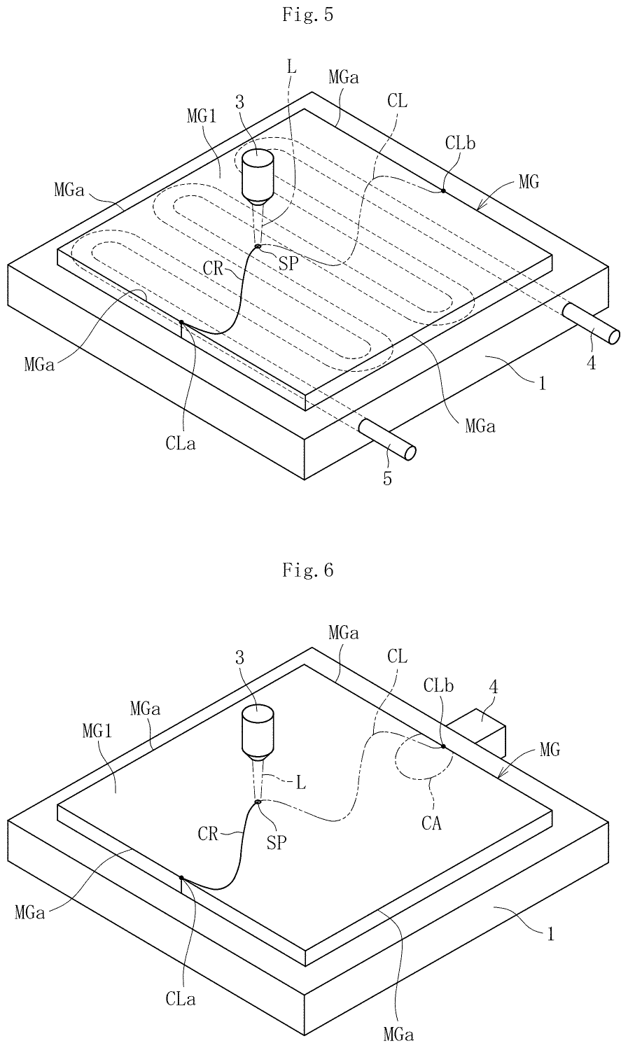

In FIG. 5, there is illustrated a method of manufacturing a glass sheet according to a third embodiment of the present invention. The third embodiment is different from the second embodiment in configuration of the cooling device 4. The cooling device 4 according to the third embodiment is provided in the surface plate 1. The cooling device 4 comprises a refrigerant pipe 5 arranged in or on a lower surface of the surface plate 1. The refrigerant pipe 5 is arranged in a meandering manner so as to cool the surface plate 1 in a wide range. In the third embodiment, in the laser irradiation step, the surface plate 1 is cooled by causing a refrigerant made of a gas or a liquid to flow through the refrigerant pipe 5. With this step, the second surface (back surface) of the mother glass sheet MG brought into contact with surface plate 1 is cooled. In the third embodiment, the second surface of the mother glass sheet MG that is brought into contact with the surface plate 1 can be cooled almost entirely, and hence the propagation of the crack CR in the thickness direction can be accelerated.

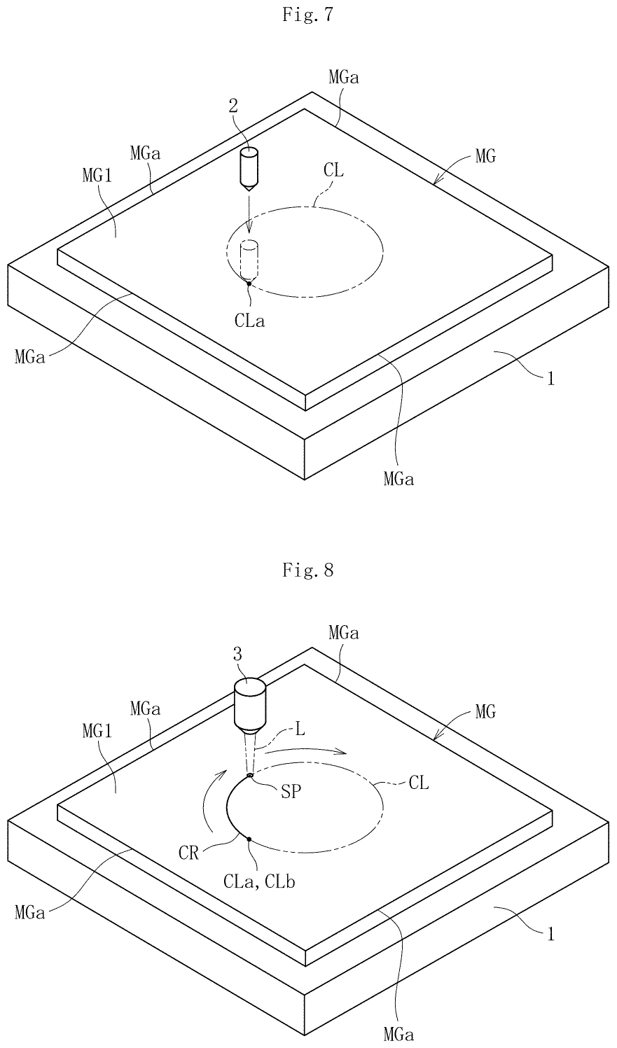

In FIG. 6, there is illustrated a method of manufacturing a glass sheet according to a fourth embodiment of the present invention. The fourth embodiment is different from the third embodiment in configuration of the cooling device 4. The cooling device 4 according to the fourth embodiment is configured to cool a part of the surface plate 1. The cooling device 4 is provided on a part of the surface plate 1 in the vicinity of the cleaving end point CLb so as to cool the cleaving end point CLb of the preset cleaving line CL set on the mother glass sheet MG and a peripheral region CA thereof. Here, in the vicinity of the cleaving end point CLb, the area for heating the glass in a cutting area is reduced, and the heating by the laser light L becomes insufficient. As a result, it is difficult to apply a thermal shock sufficient for causing the crack CR to propagate, and hence uncut portions are liable to be generated. According to the fourth embodiment, the propagation of the crack CR can be accelerated at the cleaving end point CLb, and the generation of uncut portions can be prevented.

In each of FIG. 7 and FIG. 8, there is illustrated a method of manufacturing a glass sheet according to a fifth embodiment of the present invention. In the fifth embodiment, in the initial crack forming step, an initial crack is formed in an inner region of the surface MG1 of the mother glass sheet MG instead of the edge portion MGa of the mother glass sheet MG. Here, the inner region refers to a region surrounded by the edge portion MGa (four sides of the mother glass sheet MG formed into a rectangular shape) of the mother glass sheet MG, and the edge portion MGa of the mother glass sheet MG is not comprised in the inner region.

As illustrated in FIG. 7, the circular preset cleaving line CL is set in the inner region of the mother glass sheet MG. In this case, in the initial crack forming step, the crack forming member 2 is brought into contact with an arbitrary point on the preset cleaving line CL as the cleaving start point CLa to form the initial crack.

As illustrated in FIG. 8, in the laser irradiation step, the CO laser light L is radiated to the cleaving start point CLa at which the initial crack has been formed, and the CO laser light L is scanned along the preset cleaving line CL to reach the cleaving end point CLb, with the result that a circular glass sheet can be cut out from the rectangular mother glass sheet MG.

The present invention is not limited to the configurations of the above-mentioned embodiments. In addition, the action and effect of the present invention are not limited to those described above. The present invention may be modified in various forms within the range not departing from the spirit of the present invention.

In each of the above-mentioned embodiments, there has been given the example in which laser light is radiated to the mother glass sheet as a circular laser spot, but the present invention is not limited to this configuration. The laser spot may have, for example, an elliptical shape, an oval shape, a rectangular shape, or a linear shape. From the viewpoint of increasing the scannability of laser light so as to manufacture glass sheets having various shapes, such as a curved shape, it is preferred that the laser spot be a circular laser spot. However, even when the laser spot has a shape other than the circular shape, as long as the long diameter of the shape is 10 mm or less, the mother glass sheet can be cut to an arbitrary shape by providing an angle adjusting mechanism of laser light so that the long diameter is constantly oriented in a tangent direction with respect to the preset cleaving line.

In each of the above-mentioned embodiments, there has been given the example in which the mother glass sheet formed into a rectangular shape is cut, but the present invention is not limited to this configuration. For example, also when a band-shaped glass ribbon is continuously formed by an overflow down-draw method, and the glass ribbon is cut as a mother glass sheet, the manufacturing method according to the present invention can be used.

In each of the above-mentioned embodiments, there has been exemplified the mother glass sheet MG having a flat sheet shape (the surface MG1 is a flat surface), but the present invention is not limited to this configuration. Even when the mother glass sheet MG has a curved shape (at least the surface MG1 is a curved surface), the mother glass sheet MG can be suitably cut (cleaved).

### EXAMPLES

Now, Examples according to the present invention are described, but the present invention is not limited to Examples.

The inventors of the present invention have performed a cutting test of a glass sheet through use of a laser irradiation device. In this test, mother glass sheets having different thicknesses were each continuously irradiated with CO laser light under different conditions (output, scanning speed, irradiation diameter), and each of the mother glass sheets was cleaved into a small glass sheet along a preset cleaving line formed into a curved shape (Examples 1 to 30).

The glass sheets of Examples 1 to 11 and 18 to 20 are each made of alkali-free glass (product name OA-10G manufactured by Nippon Electric Glass Co., Ltd.). The glass sheets of Examples 12 to 16 and 21 to 25 are each made of soda glass. The glass sheets of Examples 25 to 30 are each made of borosilicate glass. In Examples 1 to 3, cleaving was performed by spraying cooling air to an irradiation position of laser light.

The test conditions and test results of Examples 1 to 30 are shown in the following Tables 3 to 8. In this test, the quality of the cut surface (end surface generated by cleaving) of the glass sheet was evaluated for validity through visual observation. As evaluation, an example having end surface quality as a product was evaluated as “∘” (good), and an example having particularly high quality was evaluated as “⊚” (best).

TABLE 3

| | Example 1 | Example 2 | Example 3 | Example 4 | Example 5 |
|---|---|---|---|---|---|
| Type of glass | Alkali-free | Alkali-free | Alkali-free | Alkali-free | Alkali-free |
| Thermal expansion | 38 | 38 | 38 | 38 | 38 |
| coefficient (×10⁻⁷/K) | | | | | |
| Thickness (mm) | 0.5 | 0.5 | 0.5 | 0.5 | 0.5 |
| Output (W) | 25 | 180 | 180 | 25 | 38 |
| Speed (mm/sec) | 10 | 30 | 100 | 10 | 10 |
| Irradiation diameter (mm) | 4 | 4 | 4 | 4 | 6 |
| Cooling air (l/min) | 40 | 40 | 40 | Absent | Absent |
| Type of laser | CO | CO | CO | CO | CO |
| Evaluation of end | ◯ | ◯ | ◯ | ⊚ | ⊚ |
| surface quality | | | | | |

TABLE 4

| | Example 6 | Example 7 | Example 8 | Example 9 | Example 10 |
|---|---|---|---|---|---|
| Type of glass | Alkali-free | Alkali-free | Alkali-free | Alkali-free | Alkali-free |
| Thermal expansion | 38 | 38 | 38 | 38 | 38 |
| coefficient (×10⁻⁷/K) | | | | | |
| Thickness (mm) | 0.5 | 0.5 | 0.5 | 0.1 | 0.1 |
| Output (W) | 54 | 180 | 180 | 32 | 44 |
| Speed (mm/sec) | 10 | 100 | 30 | 200 | 200 |
| Irradiation diameter (mm) | 8 | 4 | 6 | 4 | 6 |
| Cooling air (l/min) | Absent | Absent | Absent | Absent | Absent |
| Type of laser | CO | CO | CO | CO | CO |
| Evaluation of end | ◯ | ⊚ | ⊚ | ⊚ | ⊚ |
| surface quality | | | | | |

TABLE 5

| | Example 11 | Example 12 | Example 13 | Example 14 | Example 15 |
|---|---|---|---|---|---|
| Type of glass | Alkali-free | Soda | Soda | Soda | Soda |
| Thermal expansion | 38 | 90 | 90 | 90 | 90 |
| coefficient (×10⁻⁷/K) | | | | | |
| Thickness (mm) | 0.1 | 0.5 | 0.5 | 0.7 | 1.3 |
| Output (W) | 20 | 38 | 38 | 38 | 38 |
| Speed (mm/sec) | 50 | 30 | 50 | 30 | 15 |
| Irradiation diameter (mm) | 6 | 6 | 6 | 6 | 6 |
| Cooling air (l/min) | Absent | Absent | Absent | Absent | Absent |
| Type of laser | CO | CO | CO | CO | CO |
| Evaluation of end | ⊚ | ◯ | ⊚ | ◯ | ◯ |
| surface quality | | | | | |

TABLE 6

| | Example 16 | Example 17 | Example 18 | Example 19 | Example 20 |
|---|---|---|---|---|---|
| Type of glass | Soda | Soda | Alkali-free | Alkali-free | Alkali-free |
| Thermal expansion | 90 | 90 | 38 | 38 | 38 |
| coefficient (×10⁻⁷/K) | | | | | |
| Thickness (mm) | 1.3 | 2.9 | 0.2 | 0.2 | 0.5 |
| Output (W) | 44 | 70 | 20 | 10 | 20 |
| Speed (mm/sec) | 10 | 30 | 30 | 10 | 15 |
| Irradiation diameter (mm) | 6 | 6 | 4 | 6 | 4 |
| Cooling air (l/min) | Absent | Absent | Absent | Absent | Absent |
| Type of laser | CO | CO | CO | CO | CO |
| Evaluation of end | ⊚ | ◯ | ⊚ | ◯ | ⊚ |
| surface quality | | | | | |

TABLE 7

| | Example 21 | Example 22 | Example 23 | Example 24 | Example 25 |
|---|---|---|---|---|---|
| Type of glass | Soda | Soda | Soda | Soda | Soda |
| Thermal expansion | 91 | 91 | 91 | 91 | 91 |
| coefficient (×10⁻⁷/K) | | | | | |
| Thickness (mm) | 0.7 | 0.7 | 0.7 | 0.7 | 0.7 |
| Output (W) | 13 | 22 | 52 | 52 | 73 |
| Speed (mm/sec) | 10 | 40 | 70 | 90 | 140 |
| Irradiation diameter (mm) | 6 | 6 | 6 | 6 | 6 |
| Cooling air (l/min) | Absent | Absent | Absent | Absent | Absent |
| Type of laser | CO | CO | CO | CO | CO |
| Evaluation of end | ◯ | ◯ | ⊚ | ⊚ | ⊚ |
| surface quality | | | | | |

TABLE 8

| | Example 26 | Example 27 | Example 28 | Example 29 | Example 30 |
|---|---|---|---|---|---|
| Type of glass | Borosilicate | Borosilicate | Borosilicate | Borosilicate | Borosilicate |
| Thermal expansion | 66 | 66 | 66 | 32 | 32 |
| coefficient (×10⁻⁷/K) | | | | | |
| Thickness (mm) | 0.7 | 0.7 | 0.7 | 0.7 | 0.7 |
| Output (W) | 22 | 38 | 72 | 38 | 52 |
| Speed (mm/sec) | 20 | 40 | 80 | 15 | 15 |
| Irradiation diameter (mm) | 6 | 6 | 6 | 6 | 8 |
| Cooling air (l/min) | Absent | Absent | Absent | Absent | Absent |
| Type of laser | CO | CO | CO | CO | CO |
| Evaluation of end | ◯ | ⊚ | ⊚ | ⊚ | ⊚ |
| surface quality | | | | | |

As shown in Tables 3 to 8 above, in Examples 1 to 30, through use of the CO laser light, the mother glass sheet was able to be satisfactorily cleaved. In particular, in Examples 4, 5, 7 to 11, 13, 16, 18, 20, 23 to 25, and 27 to 30, a cleaved surface of high quality was able to be formed, and hence the evaluation of end surface quality thereof was determined to be “⊚”. In addition, in Examples 4 to 30, the mother glass sheets having various thermal expansion coefficients were able to be satisfactorily cleaved without using cooling air.

In addition, for example, a thermal stress σ_{T} (MPa) when the mother glass sheet having a thickness of 0.5 mm was cut was calculated by the following expression (1). The calculation results are shown in Table 9.

$${σ}_{T} = \frac{E \cdot α \cdot Δ T}{2 ( 1 - v )} \qquad ( 1 )$$

where E represents a Young's modulus (MPa) of the mother glass sheet, α represents a thermal expansion coefficient (/K) of the mother glass sheet, ν represents a Poisson's ratio of the mother glass sheet, and ΔT represents a difference between a temperature (K) at the irradiation position of the laser light with respect to the mother glass sheet and a temperature (K) at a position away from the irradiation position.

TABLE 9

| | Type of glass | | | | |
|---|---|---|---|---|---|
| | Alkali- | Alkali- | Boro- | | |
| | free | free | silicate | Soda | Soda |
| Young's modulus | 73 | 80 | 77 | 73 | 70 |
| (GPa) | | | | | |
| Thermal expansion | 38 | 45 | 66 | 90 | 91 |
| coefficient | | | | | |
| (×10⁻⁷/K) | | | | | |
| Poisson's ratio | 0.2 | 0.2 | 0.2 | 0.2 | 0.2 |
| Thickness (mm) | 0.5 | 0.5 | 0.5 | 0.5 | 0.55 |
| Output (W) | 38 | 38 | 38 | 38 | 38 |
| Speed (mm/sec) | 20 | 40 | 70 | 90 | 90 |
| Irradiation | 6 | 6 | 6 | 6 | 6 |
| diameter (mm) | | | | | |
| ΔT (K) | 550 | 420 | 320 | 250 | 260 |
| σ_{T} (MPa) | 95 | 95 | 102 | 103 | 104 |

As shown in Table 9, in order to obtain a satisfactory cut surface with a mother glass sheet having a thickness of about 0.5 mm, it is desired that a thermal stress σ_{T} of about 100 MPa be applied to the mother glass sheet at the time of cutting regardless of the type of glass.

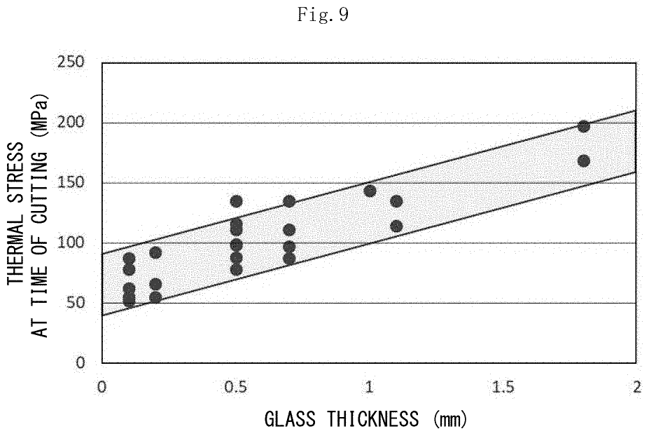

The thermal stress σ_{T} for obtaining an appropriate cut surface varies depending on the thickness of the mother glass sheet. The inventors of the present invention have conducted a test in which a plurality of mother glass sheets having different thicknesses were cut with a CO laser, and have confirmed the relationship between the thickness of the mother glass sheet and thermal stress. This cutting test was performed on alkali-free glass, soda glass, and borosilicate glass as samples of the mother glass sheet. In FIG. 9, there is shown the relationship between the thickness of the mother glass sheet and the thermal stress in the cutting test. Under the test conditions shown in FIG. 9, satisfactory cut surfaces were able to be obtained in all the cases.

From the test results, the inventors of the present invention have found that it is desired that, in order to obtain a satisfactory cut surface when a mother glass sheet is cut with a CO laser, the laser irradiation step be performed so that the thermal stress σ_{T} (MPa) of the mother glass sheet calculated by the above-mentioned expression (1) satisfies the following expression (2).

40+60t≤σ_{T}σ90+60t (2)

where “t” represents a thickness (mm) of the mother glass sheet.

Regarding the temperature measurement of the mother glass sheet, the upper surface temperature of the mother glass sheet was measured by glass temperature measurement thermography (PI450G7 manufactured by Optris) at each of an irradiation position of laser light and a separation position that was separated by 10 mm forward from the irradiation position. The difference between the temperature at the irradiation position of the laser light and the temperature at the separation position separated from the irradiation position was defined as the above-mentioned temperature difference ΔT. The temperature of the mother glass sheet during irradiation of the laser light was changed by changing the output and the processing speed condition. The temperature at the separation position was substantially the same as room temperature.

Through the cutting test, the inventors of the present invention have found a phenomenon in which, depending on the condition such as the cutting position of the mother glass sheet, when a crack is caused to propagate along a linear preset cleaving line, the crack slightly deviates from the preset cleaving line. In view of the foregoing, the inventors of the present invention have conducted a test for measuring the degree of deviation of the crack when the mother glass sheet was linearly cut.

In this test, a plurality of mother glass sheets (Examples 31 to 45) each having a square shape (150 mm×150 mm) and a thickness of 0.5 mm were prepared. The mother glass sheets of Examples 31 to 45 are made of alkali-free glass (OA-10G). The thermal expansion coefficient of each of the mother glass sheets of Examples 31 to 45 is 38×10⁻⁷/K.

In this test, the mother glass sheets of Examples 31 to 45 were cut under conditions, such as the scanning speed of CO laser light (irradiation diameter: 6 mm, output: 38 W), the cutting position, and the presence or absence of cooling air, being varied. In addition, in Examples 31 to 45, the amount (mm) of the deviation of the crack from the preset cleaving line was measured.

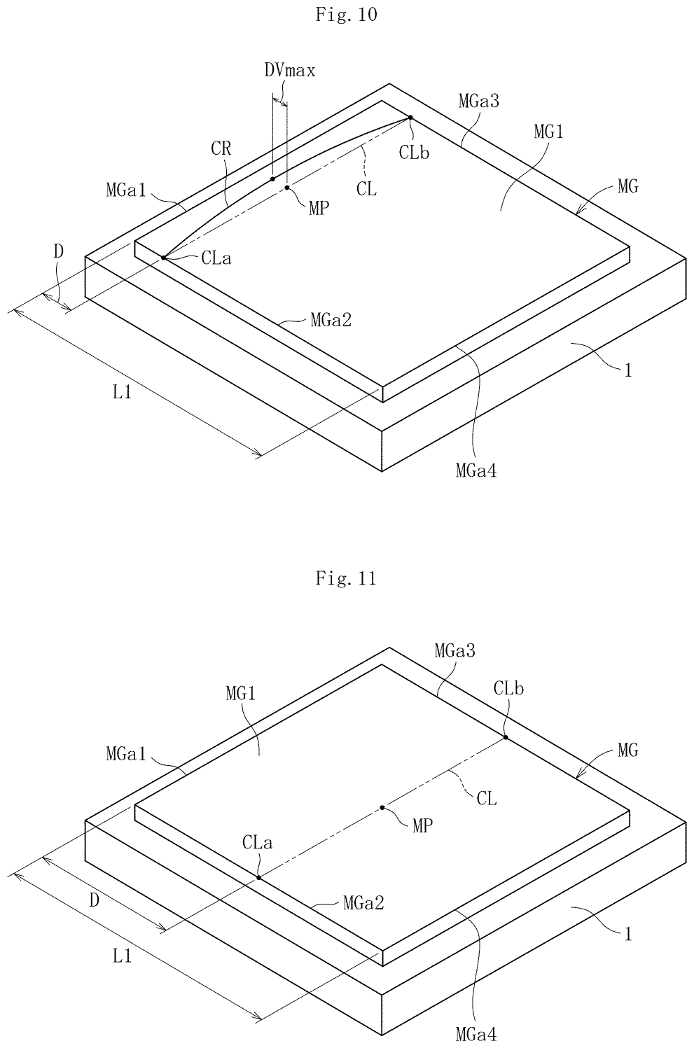

Now, the cutting position of the mother glass sheet in Examples 31 to 45 is described in detail with reference to FIG. 10 and FIG. 11.

In FIG. 10, there is illustrated a cutting position of each of the mother glass sheets of Examples 31 to 33. The mother glass sheets MG of Examples 31 to 33 each have four sides (first to fourth sides) MGa1 to MGa4. The preset cleaving line CL is a straight line set to be substantially parallel to the first side MGa1. The cleaving start point CLa of the preset cleaving line CL is set to the second side MGa2 orthogonal to the first side MGa1. The cleaving end point CLb of the preset cleaving line CL is set to the third side MGa3 that is substantially parallel to the second side MGa2.

The preset cleaving line CL is set at a position separated by a predetermined distance D from the first side MGa1 of the mother glass sheet MG. The separation distance D between the first side MGa1 and the preset cleaving line CL is equal to a ⅛ length of a length L1 of the second side MGa2.

In Examples 31 to 33, the mother glass sheet MG was cut in the same manner as in the first embodiment without using cooling air while varying the scanning speed of the CO laser light. In this case, the crack CR propagated in a curved shape (arc shape) under a state of slightly deviating from the preset cleaving line CL.

It was found that, when the deviation of the crack CR occurred, the deviation amount thereof (distance from the preset cleaving line CL to the crack CR) was the largest at an intermediate position MP of the preset cleaving line CL (position of a half length of the preset cleaving line CL). In FIG. 10, a maximum deviation amount of the crack CR corresponding to the intermediate position MP of the preset cleaving line CL in Examples 31 to 33 is indicated by the symbol DVmax.

In FIG. 11, there is illustrated a cutting position of the mother glass sheet of Example 34. In Example 34, the position of the preset cleaving line CL (distance D from the first side MGa1) is different from that of the above-mentioned Examples 31 to 33. The separation distance D between the first side MGa1 and the preset cleaving line CL in Example 34 is equal to a half length of the length L1 of the second side MGa2.

In Examples 35 to 45, the mother glass sheet was cut at the same cutting position as that in Examples 31 to 33 (see FIG. 10). In Examples 35 to 45, the mother glass sheet was cut through use of cooling air while varying the scanning speed of the CO laser light. Regarding the cooling air in Examples 35 to 45, the condition was divided into a case in which the jetting range of the cooling air partially overlapped a laser spot of the CO laser light and a case in which the cooling air was jetted toward a position away from the laser spot. In addition, in Examples 35 to 45, the position of a nozzle of a cooling device with respect to the laser irradiation device was divided into the front, the back, and the side, and the mother glass sheet was cut.

In the following Tables 10 to 12, there are shown the scanning speed of the laser light, the condition of the cooling air, and the measured value of the maximum deviation amount of the crack (DVmax) in each of Examples 31 to 45. The “position of cooling air” in Tables 10 to 12 indicates a separation distance (mm) between the jetting range of the cooling air having been brought into contact with the mother glass sheet and the laser spot when the cooling air was jetted toward a position away from the laser spot.

TABLE 10

| | Example 31 | Example 32 | Example 33 | Example 34 | Example 35 |
|---|---|---|---|---|---|
| Speed (mm/sec) | 5 | 10 | 20 | 20 | 20 |
| Cooling air (l/min) | Absent | Absent | Absent | Absent | 20 |
| Position of cooling | — | — | — | — | — |
| air (mm) | | | | | |
| Overlapping with | — | — | — | — | Partially |
| laser | | | | | overlapped |
| Position of nozzle | — | — | — | — | Back |
| Maximum deviation | 0.47 | 0.60 | 0.67 | 0 | 0.42 |
| amount (mm) | | | | | |

TABLE 11

| | Example 36 | Example 37 | Example 38 | Example 39 | Example 40 |
|---|---|---|---|---|---|
| Speed (mm/sec) | 10 | 5 | 20 | 20 | 20 |
| Cooling air (l/min) | 20 | 20 | 20 | 20 | 20 |
| Position of cooling | — | — | 2 | 4 | — |
| air (mm) | | | | | |
| Overlapping with | Partially | Partially | Absent | Absent | Partially |
| laser | overlapped | overlapped | | | overlapped |
| Position of nozzle | Back | Back | Back | Back | Front |
| Maximum deviation | 0.18 | 0.1 | 0.3 | 0.35 | 0.38 |
| amount (mm) | | | | | |

TABLE 12

| | Example 41 | Example 42 | Example 43 | Example 44 | Example 45 |
|---|---|---|---|---|---|
| Speed (mm/sec) | 10 | 5 | 20 | 10 | 5 |
| Cooling air (l/min) | 20 | 20 | 20 | 20 | 20 |
| Position of cooling | — | — | 2 | 2 | 2 |
| air (mm) | | | | | |
| Overlapping with | Partially | Partially | Absent | Absent | Absent |
| laser | overlapped | overlapped | | | |
| Position of nozzle | Front | Front | Side | Side | Side |
| Maximum deviation | 0.25 | 0.2 | 0.4 | 0.25 | 0.2 |
| amount (mm) | | | | | |

As shown in Tables 10 to 12, when the deviation of the crack from the preset cleaving line occurs, the deviation amount can be reduced by decreasing the scanning speed of the laser light. In addition, when the preset cleaving line parallel to one side (first side MGa1) of the mother glass sheet is set so as to be sufficiently separated from the one side (Example 34), the mother glass sheet can be cut without causing the deviation of the crack. Further, when the mother glass sheet is cut through use of the cooling air (Examples 35 to 45), the deviation amount of the crack can be reduced as compared to the case without using the cooling air (Examples 31 to 33).

### REFERENCE SIGNS LIST

1 surface plate
CL preset cleaving line
CR crack
IL inner portion of mother glass sheet
L laser light
MG mother glass sheet
MG1 first surface
MG2 second surface
SL surface layer of mother glass sheet (first surface)
SP laser spot

1. A method of manufacturing a glass sheet, comprising:
an initial crack forming step of forming an initial crack on a first surface of a mother glass sheet; and
a laser irradiation step of irradiating the first surface with laser light to cause a crack to propagate along a preset cleaving line through use of the initial crack as a starting point,
wherein the laser irradiation step comprises irradiating the mother glass sheet with the laser light to heat a surface layer and an inner portion of the first surface, to thereby cause, through a thermal shock caused by the heating, the crack to propagate to a second surface of the mother glass sheet along a thickness direction of the mother glass sheet while propagating along the preset cleaving line.

2. The method of manufacturing a glass sheet according to claim 1, wherein the laser light is CO laser light.

3. A method of manufacturing a glass sheet, comprising:
an initial crack forming step of forming an initial crack on a first surface of a mother glass sheet; and
a laser irradiation step of irradiating the first surface with laser light to cause a crack to propagate along a preset cleaving line through use of the initial crack as a starting point,
wherein the laser irradiation step comprises radiating, as the laser light, CO laser light, Er laser light, Ho laser light, or HF laser light to cause the crack to propagate to a second surface of the mother glass sheet along a thickness direction of the mother glass sheet while propagating along the preset cleaving line.

4. The method of manufacturing a glass sheet according to claim 1, wherein the laser light is radiated as a circular laser spot.

5. The method of manufacturing a glass sheet according to claim 4, wherein the laser irradiation step comprises cooling a periphery of an irradiation position of the laser light.

6. The method of manufacturing a glass sheet according to claim 1, wherein the laser irradiation step comprises supporting the mother glass sheet with a surface plate and cooling the surface plate.

7. The method of manufacturing a glass sheet according to claim 6, wherein the laser irradiation step comprises cooling a part of the surface plate in a vicinity of a cleaving end point of the preset cleaving line.

8. The method of manufacturing a glass sheet according to claim 1, wherein the initial crack forming step comprises forming the initial crack in an inner region of the mother glass sheet.

9. The method of manufacturing a glass sheet according to claim 1, wherein the laser irradiation step is performed under a condition in which a thermal stress σ_{T} (MPa) of the mother glass sheet calculated by the following expression (1) satisfies the following expression (2):
$${σ}_{T} = \frac{E \cdot α \cdot Δ T}{2 ( 1 - v )} \qquad ( 1 )$$
where E represents a Young's modulus (MPa) of the mother glass sheet, α represents a thermal expansion coefficient (/K) of the mother glass sheet, v represents a Poisson's ratio of the mother glass sheet, and ΔT represents a difference between a temperature (K) at the irradiation position of the laser light with respect to the mother glass sheet and a temperature (K) at a position away from the irradiation position; and
40+60t≤σ_{T}≤90+60t (2)
where “t” represents a thickness (mm) of the mother glass sheet.

10. The method of manufacturing a glass sheet according to claim 3, wherein the laser light is radiated as a circular laser spot.

11. The method of manufacturing a glass sheet according to claim 3, wherein the laser irradiation step comprises supporting the mother glass sheet with a surface plate and cooling the surface plate.

12. The method of manufacturing a glass sheet according to claim 3, wherein the initial crack forming step comprises forming the initial crack in an inner region of the mother glass sheet.

13. The method of manufacturing a glass sheet according to claim 3, wherein the laser irradiation step is performed under a condition in which a thermal stress σ_{T} (MPa) of the mother glass sheet calculated by the following expression (1) satisfies the following expression (2):
$${σ}_{T} = \frac{E \cdot α \cdot Δ T}{2 ( 1 - v )} \qquad ( 1 )$$
where E represents a Young's modulus (MPa) of the mother glass sheet, α represents a thermal expansion coefficient (/K) of the mother glass sheet, v represents a Poisson's ratio of the mother glass sheet, and ΔT represents a difference between a temperature (K) at the irradiation position of the laser light with respect to the mother glass sheet and a temperature (K) at a position away from the irradiation position; and
40+60t≤σ_{T}σ90+60t (2)
where “t” represents a thickness (mm) of the mother glass sheet.
